(19) United States
(12) Patent Application Publication
(10) Pub. No.: US 2013/0011740 A1
(43) Pub. Date: Jan. 10, 2013

(54) Lithium Secondary Battery

(75) Inventors: Hiroaki KONISHI, Hitachi (JP); Masanori Yoshikawa, Hitachinaka (JP)

(73) Assignee: Hitachi, Ltd., Tokyo (JP)

(21) Appl. No.: 13/540,868

(22) Filed: Jul. 3, 2012

(30) Foreign Application Priority Data
Jul. 5, 2011 (JP) 2011-149033

(51) Int. Cl. H01M 4/525

(52) U.S. Cl. 429/223; 252/182.1

(57) ABSTRACT

The positive-electrode material of the lithium secondary battery according to the present invention includes a first positive-electrode active material, and a second positive-electrode active material, the first positive-electrode active material denoted by a composition formula Li_{1.1+x}NiₐM1_{b}M2_{c}O₂ (M1 denoting Mo or W, M2 denoting Co, or Co and Mn, −0.07≦x≦0.1, 0.7≦a<0.98, 0.02≦b≦0.06, 0<c≦0.28), the second positive-electrode active material denoted by a composition formula Li_{1.03+x}NiₐTi_{b}M3_{c}0₂ (M3 denoting Co, or Co and Mn, −0.03≦x≦0.07, 0.7≦a≦0.8, 0.05≦b≦0.1, 0.1≦c≦0.25), wherein the percentage of the first positive-electrode active material relative to the sum of the first positive-electrode active material and the second positive-electrode active material is greater than or equal to 30% in mass ratio.

### BACKGROUND OF THE INVENTION

The present invention relates to a positive-electrode material for a lithium secondary battery and the lithium secondary battery.

The lithium secondary battery is required to be implemented low-cost, small-volume, light-weight, and high-output while maintaining high safety that ignition or burst caused by a heat-flow reaction does not occur especially when the battery is employed as a battery for a plug-in hybrid car. On account of this situation, a lithium secondary battery having high-capacity and high-safety characteristics is demanded, so that a positive-electrode material is required for satisfying this demand.

In a lithium-ion secondary battery disclosed in JP-A-2006-302880, different species of elements exist only on the surface of positive-electrode active material, and this ensures a high-level safety at the time of the battery's internal short-circuit.

In a non-aqueous electrolyte secondary battery disclosed in JP-A-2009-224097, a Li—Ni—Mn-based positive-electrode active material and a Li—Ni—Co-based positive-electrode active material are mixed with each other, and this allows an enhancement in the reliability at the time of high-temperature storage.

In a non-aqueous electrolyte-solution secondary battery disclosed in JP-A-9-35715, the surface of a lithium-containing compound is coated with microscopic particles of a lithium-containing compound, and this ensures a large reaction area while enhancing the electrode-filling property.

### SUMMARY OF THE INVENTION

The positive-electrode material for the conventional lithium secondary battery has failed to accomplish the characteristics which are needed for the battery for the plug-in hybrid car, i.e., the high-capacity and high-safety characteristics.

For example, in the lithium-ion secondary battery disclosed in JPA-2006-302880, the different species of elements exist only on the surface of the positive-electrode active material. This makes it impossible to reduce oxygen release from inside the crystalline lattice which occurs when the temperature rises. Accordingly, there is a problem in ensuring safety of the charged state exists.

In the non-aqueous electrolyte secondary battery disclosed in JP-A-2009-224097, 20% or more Mn is contained in the Li—Ni—Mn-based positive-electrode active material. As a result, the capacity of this battery is lowered so that it cannot be said that this battery is suitable for the battery for the plug-in hybrid car use.

In the non-aqueous electrolyte-solution secondary battery disclosed in JP-A-9-35715, the positive-electrode material does not contain a replacement element which allows an improvement in the thermal stability, so that there is a problem in ensuring the safety of the battery.

It is an object of the present invention to provide a positive-electrode material which allows for achieving a high-capacity and high-safety lithium secondary battery required for the battery for the plug-in hybrid car use, and a high-capacity and high-safety lithium secondary battery.

The positive-electrode material of the lithium secondary battery according to the present invention includes a first positive-electrode active material, and a second positive-electrode active material, a first positive-electrode active material being denoted by a composition formula Li_{1.1+x}NiₐM1_{b}M2_{c}O₂ (M1 denoting Mo or W, M2 denoting Co, or Co and Mn, −0.07≦x≦0.1, 0.7≦a≦0.98, 0.02≦b≦0.06, 0<c≦0.28), a second positive-electrode active material being denoted by a composition formula Li_{1.03+x}NiₐTi_{b}M3_{c}O₂ (M3 denoting Co, or Co and Mn, −0.03≦x≦0.07, 0.7≦a≦0.8, 0.05≦b≦0.1, 0.1≦c≦0.25), wherein the percentage of the first positive-electrode active material relative to the sum of the first positive-electrode active material and the second positive-electrode active material is greater than or equal to 30% in mass ratio.

According to the present invention, it becomes possible to provide the positive electrode material which allows for achieving the high-capacity and high-safety lithium secondary battery required for the battery for the plug-in hybrid car use, and the high-capacity and high-safety lithium secondary battery.

### BRIEF DESCRIPTION OF THE DRAWINGS

FIG. 1 is a graph for illustrating the results of differential scanning heat amount measurements on prototype batteries according to Example 1 and Comparative Example 1; and

FIG. 2 is a cross-sectional view of a lithium secondary battery.

### DETAILED DESCRIPTION OF THE EMBODIMENTS

The lithium secondary battery is required to have high-capacity and high safety characteristics in order to be employed as a battery for the plug-in hybrid car. In the lithium secondary battery, the high-capacity and high-safety characteristics are closely related with the property of the positive-electrode material. In a layer-structured positive electrode active material denoted by a composition formula LiMO₂ (M denotes a transition metal), the attainment of high capacity requires an increase in the Ni content in the transition-metal layer.

However, the positive-electrode material which contains a large amount of Ni is accompanied by its low structural stability in the charged state. Accordingly, when the battery temperature rises due to internal short-circuit or the like, oxygen released from inside the positive-electrode active material and the electrolyte react with each other at a comparatively low temperature, and this reaction results in an occurrence of a significant heat-flow reaction. It is feared that this heat-flow reaction may give rise to an occurrence of ignition or burst of the battery.

The lithium secondary battery use positive-electrode material according to the present invention solves the problems as described above, and has a feature that it includes a the first positive electrode active material being denoted by a composition formula Li_{1.1+x}NiₐM1_{b}M2_{c}O₂ (M1 denoting Mo or W, M2 denoting Co, or Co and Mn, −0.07≦x≦0.1, 0.7≦a<0. 98, 0.02≦b≦0.06, 0<c≦0.28) and a second positive electrode active material being denoted by a composition formula Li_{1.03+x}NiₐTi_{b}M3_{c}O₂ (M3 denoting Co, or Co and Mn, −0.03≦x≦0.07, 0.7≦a≦0.8, 0.05≦b≦0.1, 0.1<c≦0.25). Here, the percentage of the first positive electrode active material relative to the sum of the first positive electrode active material and the second positive-electrode active material is greater than or equal to 30% in mass ratio.

The lithium secondary battery according to the present invention includes a positive electrode capable of storing/releasing lithium, a negative electrode capable of storing/releasing lithium, and separators, wherein the positive electrode material according to the present invention is used for this positive electrode.

The positive-electrode active material which has a large amount of Ni content allows for attaining a high capacity, however, is accompanied by a drawback that its thermal stability in the charged state is low. Accordingly, the positive-electrode active material having the large amount of Ni content is doped with Mo or W, thereby forming a first positive-electrode active material, and the thermal stability in the charged state was improved. Moreover, another positive-electrode active material having the large amount of Ni content is doped with Ti, thereby forming a second positive-electrode active material. The use of a positive-electrode material formed by mixing the first positive-electrode active material and the second positive-electrode active material with each other makes it possible to improve the thermal stability in the charged state even further. Mo, W, and Ti are elements capable of reducing a maximum heat-flow value, and capable of enhancing the thermal stability in the charged state.

When Mo or W and Ti are directly mixed with each other, they are not successfully mixed even if a firing treatment is applied thereto so that the formation of the positive-electrode active material is difficult. Consequently, in the present invention, the first positive-electrode active material is doped with Mo or W, and the second positive-electrode active material is doped with. Ti. After that, the first positive-electrode active material and the second positive-electrode active material are mixed with each other, thereby forming the positive-electrode material.

In the positive-electrode material according to the present invention, the heat-flow amount, which is liberated when the battery temperature rises together with the electrolyte solution, is tremendously reduced as compared with the positive-electrode active material which has a large amount of Ni content and does not contain the doped element (i.e., Mo, W, or Ti). This feature makes it possible to reduce the possibility that the battery may fall into ignition or burst when the battery temperature rises, thereby allowing for enhancing the safety.

The use of the present positive-electrode material makes it possible to provide the positive-electrode material of the lithium secondary battery which allows for enhancing the safety by reducing the possibility that the battery may fall into ignition or burst when the battery temperature rises.

Here, the explanation will be given below concerning the first positive-electrode active material.

The Li content of the first positive-electrode active material, namely, the percentage of Li relative to the transition metal (i.e., 1.1+x in the above-described composition formula) is set to be greater than or equal to 1.03, and is set to be smaller than or equal to 1.2 (i.e., −0.07≦x≦0.1). If the Li content is smaller than 1.03 (i.e., x<−0.07), the amount of Li existing in the Li layer is small. As a result, the layer structure cannot be maintained so that the capacity becomes lowered. Meanwhile, if the Li content is greater than 1.2 (i.e., x>0.1), the amount of the transition metal in the composite oxide is decreased so that the capacity becomes lowered.

The Ni content of the first positive-electrode active material is denoted by a in the above-described composition formula, and 0.7≦a<0.98 is set. If a<0.7, the content of Ni which makes a main contribution to the charge/discharge reaction is decreased so that the capacity becomes lowered. If a≧0.98, the content of the other elements (M2 in particular) is decreased so that the thermal stability becomes lowered.

The M1 content of the first positive-electrode active material is denoted by b in the above-described composition formula, and 0.02≦b≦0.06 is set. If b<0.02, the thermal stability in the charged state cannot be improved. If b>0.06, the crystal structure becomes unstable so that the capacity becomes lowered.

The M2 content of the first positive-electrode active material is denoted by c in the above-described composition formula, and 0<c≦0.28 is set. If c>0.28, the content of Ni which makes the main contribution to the charge/discharge reaction is decreased so that the capacity becomes lowered.

Next, explanation will be given below regarding the second positive-electrode active material.

The Li content of the second positive-electrode active material, namely, the percentage of Li relative to the transition metal (i.e., 1.03+x in the above-described composition formula) is set to be greater than or equal to 1.00, and is set to be smaller than or equal to 1.1 (i.e., −0.03≦x≦0.07). If the Li content is smaller than 1.00 (i.e., x<−0.03), the amount of Li existing in the Li layer is small. As a result, the layer structure cannot be maintained so that the capacity becomes lowered. If the Li content is greater than 1.1 (i.e., x>0.07), the amount of the transition metal in the composite oxide is decreased so that the capacity becomes lowered.

The Ni content of the second positive-electrode active material is denoted by a in the above-described composition formula, and 0.7≦a≦0.8 is set. If a<0.7, the content of Ni which makes the main contribution to the charge/discharge reaction is decreased so that the capacity becomes lowered. If a>0.8, the content of the other elements (M3 in particular) is decreased so that the thermal stability becomes lowered.

The Ti content of the second positive-electrode active material is denoted by b in the above-described composition formula, and 0.05<b≦0.1 is set. If b<0.05, the thermal stability in the charged state cannot be improved. If b>0.1, the content of Ni which makes the main contribution to the charge/discharge reaction is decreased so that the capacity becomes lowered.

The M3 content of the second positive-electrode active material is denoted by c in the above-described composition formula, and 0.1≦c≦0.25 is set. If c<0.1, the crystal structure in the charged state becomes unstable. If c>0.25, the content of Ni which makes the main contribution to the charge/discharge reaction is decreased so that the capacity becomes lowered.

### (Preparation of Positive-Electrode Active Materials)

Next, explanation will be given below concerning a preparation method of preparing the first positive-electrode active materials and the second positive-electrode active materials used in Examples and Comparative Examples which will be described later. Both the first positive-electrode active materials and the second positive-electrode active materials have been prepared using a similar method. In Examples and Comparative Examples, as represented in Table 1 and Table 2 which will be represented later, 14 types of first positive-electrode active materials and 16 types of second positive-electrode active materials were prepared.

As raw materials, nickel oxide and cobalt oxide were used. Moreover, in harmony with the compositions represented in Table 1 and Table 2, one or two elements are selected and used from among manganese dioxide, molybdenum oxide, tungsten oxide, titanium oxide, zirconium oxide, aluminum oxide, and magnesium oxide. These oxides were balance-measured so that they constitute predetermined atomic ratios. Furthermore, these oxides are formed into slurry by adding pure water thereto.

This slurry is pulverized using a beads mill of zirconia until its average particle diameter becomes equal to 0.2 μm. Moreover, this pulverized slurry was added with a 1 wt. % polyvinyl alcohol (PVA) solution in solid division ratio, then mixed with this solution for 1 hour. After that, this mixed slurry is granulated and dried using a spray drier.

Lithium hydroxide and lithium carbonate were added to this granulated particle so that the ratio between Li and the transition metal becomes equal to 1.1:1.

Next, powder, which was obtained by adding lithium hydroxide and lithium carbonate to the granulated particle, was fired at 800° C. and for 10 hours, thereby forming a layer structure. After that, this crystal was pulverized, thereby obtaining a positive-electrode active material. Then, coarse particles whose particle diameter is equal to 30 μm or greater were removed by the classification. After that, a positive electrode is formed using this positive-electrode active material.

The preparation method of preparing the first positive-electrode active material and the second positive-electrode active material according to the present invention is not limited to the above-described method. Namely, some other method such as the coprecipitation method may also be used.

Table 1 represents composition ratios of the metals of each of the 14 types of first positive-electrode active materials synthesized in Examples and Comparative Examples. Table 2 represents composition ratios of the metals of each of the 16 types of second positive-electrode active materials synthesized in Examples and Comparative Examples. Table 1 and Table 2 represent the content of Li and the contents of the respective types of transition metals when the sum of the transition metals of each of the first positive-electrode active materials and the sum of the transition metals of each of the second positive-electrode active materials are respectively set at 100. The positive-electrode active materials formed in Examples and Comparative Examples are the 14 types of first positive-electrode active materials, i.e., positive-electrode active materials 1-1 to 1-14, and the 16 types of second positive-electrode active materials, i.e., positive-electrode active materials 2-1 to 2-16.

TABLE 1

| | COMPOSITION | | | | | |
|---|---|---|---|---|---|---|
| | Li | Ni | Mn | Co | Mo | W |
| POSITIVE-ELECTRODE ACTIVE | 110 | 80 | — | 16 | 4 | — |
| MATERIAL 1-1 | | | | | | |
| POSITIVE-ELECTRODE ACTIVE | 110 | 80 | — | 16 | | 4 |
| MATERIAL 1-2 | | | | | | |
| POSITIVE-ELECTRODE ACTIVE | 110 | 80 | 4 | 12 | 4 | — |
| MATERIAL 1-3 | | | | | | |
| POSITIVE-ELECTRODE ACTIVE | 110 | 80 | 8 | 8 | 4 | — |
| MATERIAL 1-4 | | | | | | |
| POSITIVE-ELECTRODE ACTIVE | 110 | 80 | — | 20 | — | — |
| MATERIAL 1-5 | | | | | | |
| POSITIVE-ELECTRODE ACTIVE | 110 | 80 | — | 18 | 2 | — |
| MATERIAL 1-6 | | | | | | |
| POSITIVE-ELECTRODE ACTIVE | 110 | 80 | — | 14 | 6 | — |
| MATERIAL 1-7 | | | | | | |
| POSITIVE-ELECTRODE ACTIVE | 110 | 80 | — | 12 | 8 | — |
| MATERIAL 1-8 | | | | | | |
| POSITIVE-ELECTRODE ACTIVE | 100 | 80 | — | 16 | 4 | — |
| MATERIAL 1-9 | | | | | | |
| POSITIVE-ELECTRODE ACTIVE | 103 | 80 | — | 16 | 4 | — |
| MATERIAL 1-10 | | | | | | |
| POSITIVE-ELECTRODE ACTIVE | 120 | 80 | — | 16 | 4 | — |
| MATERIAL 1-11 | | | | | | |
| POSITIVE-ELECTRODE ACTIVE | 125 | 80 | — | 16 | 4 | — |
| MATERIAL 1-12 | | | | | | |
| POSITIVE-ELECTRODE ACTIVE | 110 | 70 | — | 26 | 4 | — |
| MATERIAL 1-13 | | | | | | |
| POSITIVE-ELECTRODE ACTIVE | 110 | 60 | — | 36 | 4 | — |
| MATERIAL 1-14 | | | | | | |

TABLE 2

| | COMPOSITION | | | | | | | |
|---|---|---|---|---|---|---|---|---|
| | Li | Ni | Mn | Co | Ti | Zr | Al | Mg |
| POSITIVE-ELECTRODE ACTIVE | 103 | 60 | 20 | 20 | — | — | — | — |
| MATERIAL 2-1 | | | | | | | | |
| POSITIVE-ELECTRODE ACTIVE | 103 | 80 | — | 10 | 10 | — | — | — |
| MATERIAL 2-2 | | | | | | | | |
| POSITIVE-ELECTRODE ACTIVE | 103 | 80 | — | 10 | — | 10 | — | — |
| MATERIAL 2-3 | | | | | | | | |
| POSITIVE-ELECTRODE ACTIVE | 103 | 80 | — | 10 | — | — | 10 | — |
| MATERIAL 2-4 | | | | | | | | |
| POSITIVE-ELECTRODE ACTIVE | 103 | 80 | — | 10 | — | — | — | 10 |
| MATERIAL 2-5 | | | | | | | | |
| POSITIVE-ELECTRODE ACTIVE | 103 | 70 | 5 | 15 | 10 | — | — | — |
| MATERIAL 2-6 | | | | | | | | |
| POSITIVE-ELECTRODE ACTIVE | 103 | 70 | 10 | 10 | 10 | — | — | — |
| MATERIAL 2-7 | | | | | | | | |
| POSITIVE-ELECTRODE ACTIVE | 103 | 70 | 15 | 5 | 10 | — | — | — |
| MATERIAL 2-8 | | | | | | | | |
| POSITIVE-ELECTRODE ACTIVE | 103 | 70 | 10 | 15 | 5 | — | — | — |
| MATERIAL 2-9 | | | | | | | | |
| POSITIVE-ELECTRODE ACTIVE | 103 | 70 | 10 | 5 | 15 | — | — | — |
| MATERIAL 2-10 | | | | | | | | |
| POSITIVE-ELECTRODE ACTIVE | 97 | 80 | — | 10 | 10 | — | — | — |
| MATERIAL 2-11 | | | | | | | | |
| POSITIVE-ELECTRODE ACTIVE | 100 | 80 | — | 10 | 10 | — | — | — |
| MATERIAL 2-12 | | | | | | | | |
| POSITIVE-ELECTRODE ACTIVE | 110 | 80 | — | 10 | 10 | — | — | — |
| MATERIAL 2-13 | | | | | | | | |
| POSITIVE-ELECTRODE ACTIVE | 115 | 80 | — | 10 | 10 | — | — | — |
| MATERIAL 2-14 | | | | | | | | |
| POSITIVE-ELECTRODE ACTIVE | 103 | 90 | — | — | 10 | — | — | — |
| MATERIAL 2-15 | | | | | | | | |
| POSITIVE-ELECTRODE ACTIVE | 103 | 60 | — | 30 | 10 | — | — | — |
| MATERIAL 2-16 | | | | | | | | |

### (Preparation of Positive-Electrode Materials)

Next, explanation will be given below regarding a preparation method of preparing the positive-electrode materials used in Examples and Comparative Examples. In Examples and Comparative Examples, as are represented in Table 3, 30 types of positive-electrode materials were prepared using the 14 types of first positive-electrode active materials and the 16 types of second positive-electrode active materials prepared as represented above. Table 3 represents the combination and the mixture ratios (i.e., mass ratios) of first positive-electrode active materials and second positive-electrode active materials in Examples 1 to 16 and Comparative Examples 1 to 16.

TABLE 3

| | POSITIVE-ELECTRODE | | | |
|---|---|---|---|---|
| | ACTIVE MATERIAL | | MIXTURE RATIO | |
| | FIRST | SECOND | FIRST | SECOND |
| | POSITIVE- | POSITIVE- | POSITIVE- | POSITIVE- |
| | ELECTRODE | ELECTRODE | ELECTRODE | ELECTRODE |
| | ACTIVE | ACTIVE | ACTIVE | ACTIVE |
| | MATERIAL | MATERIAL | MATERIAL | MATERIAL |
| EXAMPLE 1 | 1-1 | 2-2 | 50 | 50 |
| EXAMPLE 2 | 1-2 | 2-2 | 50 | 50 |
| EXAMPLE 3 | 1-3 | 2-2 | 50 | 50 |
| EXAMPLE 4 | 1-4 | 2-2 | 50 | 50 |
| EXAMPLE 5 | 1-1 | 2-6 | 50 | 50 |
| EXAMPLE 6 | 1-1 | 2-7 | 50 | 50 |
| EXAMPLE 7 | 1-6 | 2-2 | 50 | 50 |
| EXAMPLE 8 | 1-7 | 2-2 | 50 | 50 |
| EXAMPLE 9 | 1-1 | 2-9 | 50 | 50 |
| EXAMPLE 10 | 1-10 | 2-2 | 50 | 50 |
| EXAMPLE 11 | 1-11 | 2-2 | 50 | 50 |
| EXAMPLE 12 | 1-1 | 2-12 | 50 | 50 |
| EXAMPLE 13 | 1-1 | 2-13 | 50 | 50 |
| EXAMPLE 14 | 1-13 | 2-2 | 50 | 50 |
| EXAMPLE 15 | 1-1 | 2-2 | 70 | 30 |
| EXAMPLE 16 | 1-1 | 2-2 | 30 | 70 |
| COMPARATIVE | — | 2-1 | 0 | 100 |
| EXAMPLE 1 | | | | |
| COMPARATIVE | 1-1 | 2-3 | 50 | 50 |
| EXAMPLE 2 | | | | |
| COMPARATIVE | 1-1 | 2-4 | 50 | 50 |
| EXAMPLE 3 | | | | |
| COMPARATIVE | 1-1 | 2-5 | 50 | 50 |
| EXAMPLE 4 | | | | |
| COMPARATIVE | 1-5 | 2-8 | 50 | 50 |
| EXAMPLE 5 | | | | |
| COMPARATIVE | 1-5 | 2-2 | 50 | 50 |
| EXAMPLE 6 | | | | |
| COMPARATIVE | 1-8 | 2-2 | 50 | 50 |
| EXAMPLE 7 | | | | |
| COMPARATIVE | 1-1 | 2-10 | 50 | 50 |
| EXAMPLE 8 | | | | |
| COMPARATIVE | 1-9 | 2-2 | 50 | 50 |
| EXAMPLE 9 | | | | |
| COMPARATIVE | 1-10 | 2-2 | 50 | 50 |
| EXAMPLE 10 | | | | |
| COMPARATIVE | 1-1 | 2-11 | 50 | 50 |
| EXAMPLE 11 | | | | |
| COMPARATIVE | 1-1 | 2-14 | 50 | 50 |
| EXAMPLE 12 | | | | |
| COMPARATIVE | 1-14 | 2-2 | 50 | 50 |
| EXAMPLE 13 | | | | |
| COMPARATIVE | 1-1 | 2-15 | 50 | 50 |
| EXAMPLE 14 | | | | |
| COMPARATIVE | 1-1 | 2-16 | 50 | 50 |
| EXAMPLE 15 | | | | |
| COMPARATIVE | 1-1 | 2-2 | 20 | 80 |
| EXAMPLE 16 | | | | |

First, in Examples 1 to 16 and Comparative Examples 1 to 16, the first positive-electrode active materials and the second positive-electrode active materials are combined with each other as represented in Table 3. Moreover, the first materials and the second materials were balance-measured, and mixed with each other so that they constitute the mixture ratios (i.e., mass ratios) represented in Table 3.

The mixed positive-electrode active materials and a carbon-based electrically-conductive agent were balance-measured, and mixed with each other using a mortar so that they constitute 85:10.7 in mass ratio. Furthermore, the mixture material of the positive-electrode active materials and the electrically-conductive agent and an adhesive agent dissolved into N-methyl-2-pyrrolidone (NMP) were formed into slurry by mixing the mixture material and the adhesive agent with each other so that the mass ratio between them becomes equal to 95.7:4.3. This slurry is the positive-electrode material.

### (Fabrication of Prototype Batteries)

In Examples 1 to 16 and Comparative Examples 1 to 16, positive electrodes were formed using the 30 types of positive-electrode materials prepared as represented above, and 32 types of prototype batteries were formed.

Next, explanation will be given below concerning a formation method of forming a positive electrode. The uniformly mixed slurry (i.e., the positive-electrode material) was pasted on a 20 μm thick aluminum electricity collector foil. After that, this slurry was dried at 120° C., and was compression formed using a press so that the electrode density becomes equal to 2.7 g/cm³, thereby obtaining an electrode plate. After that, this electrode plate was stamped into a 15 mm diameter circular-plate profile. In this way, the positive electrode was formed.

A negative electrode was formed using metal lithium. The non-aqueous electrolyte solution used was produced by dissolving 1.0 mol/litter LiPF₆ into a mixture solvent of EC (ethylene carbonate) and DMC (dimethyl carbonate) constituting 1:2 in the volume ratio.

In Examples 1 to 16 and Comparative Examples 1 to 16, charge/discharge tests and differential-scanning heat amount measurements were performed with respect to the 32 types of prototype batteries fabricated as represented above (the combination and the mixture ratio of the first positive-electrode active material and the second positive-electrode active material in each of Examples 1 to 16 and Comparative Examples 1 to 16 are represented in Table 3).

### (Charge/Discharge Tests)

A prototype battery was initialized, setting an upper limit voltage as 4.3 V, a lower limit voltage as 2.7 V and at 0.1 C, by repeating charge/discharge three times. Further, with the 4.3 V upper limit voltage 2.7 V lower limit voltage and 0.1 C, charge/discharge was performed and the discharge capacity was measured.

### (Differential-Scanning Heat Amount Measurements)

The prototype battery was charged up to 4.3 V at a constant current/constant voltage, and then the positive electrode taken out of the battery was washed with DMC. After that, the positive electrode was stamped into a 3.5 mm diameter circular-plate profile, then put into a sample pan. Furthermore, the sample pan is formed into a sample by adding 1 μl (litter) electrolyte solution therein and hermetically sealed.

An investigation was made with respect to the heat flow behavior of this sample at the time when the sample's temperature is raised from the room temperature up to 400° C. at a rate of 5° C./min.

Tables 4 to 9 represent capacity ratios and maximum heat-flow value ratios as the results of the charge/discharge tests and the differential-scanning heat amount measurements in Examples 1 to 16 and Comparative Examples 1 to 16. Also represented are combinations of first positive-electrode active materials and second positive-electrode active materials which were used. Tables 7 to 9 further represent mixture ratios in parentheses. When no mixture ratio is represented, the mixture ratio of the first positive-electrode active material and the second positive-electrode active material is equal to 50:50 in mass ratio.

As for the results of the charge/discharge tests of Examples 1 to 16 and Comparative Examples 1 to 16, values which were obtained by dividing the discharge capacities by the discharge capacity of Comparative Example 1 are represented as capacity ratios in Tables 4 to 9.

As for the results the differential-scanning heat amount measurements of Examples 1 to 16 and Comparative Examples 1 to 16, values which were obtained by dividing the maximum heat-flow values (maximum heat-flow values) by the maximum heat-flow value of Comparative Example 1 are represented as maximum heat-flow value ratios in Tables 4 to 9.

TABLE 4

| | | | FIRST | SECOND |
|---|---|---|---|---|
| | | | POSITIVE- | POSITIVE- |
| | | MAXIMUM | ELECTRODE | ELECTRODE |
| | CAPACITY | HEAT-FLOW | ACTIVE | ACTIVE |
| | RATIO | VALUE RATIO | MATERIAL | MATERIAL |
| EXAMPLE 1 | 1.14 | 0.29 | 1-1 | 2-2 |
| EXAMPLE 2 | 1.11 | 0.27 | 1-2 | 2-2 |
| EXAMPLE 3 | 1.13 | 0.29 | 1-3 | 2-2 |
| EXAMPLE 4 | 1.08 | 0.28 | 1-4 | 2-2 |
| COMPARATIVE | 1 | 1 | — | 2-1 |
| EXAMPLE 1 | | | | |
| COMPARATIVE | 0.96 | 0.59 | 1-1 | 2-3 |
| EXAMPLE 2 | | | | |
| COMPARATIVE | 1.15 | 0.55 | 1-1 | 2-4 |
| EXAMPLE 3 | | | | |
| COMPARATIVE | 0.97 | 0.56 | 1-1 | 2-5 |
| EXAMPLE 4 | | | | |

TABLE 5

| | | | FIRST | SECOND |
|---|---|---|---|---|
| | | | POSITIVE- | POSITIVE- |
| | | MAXIMUM | ELECTRODE | ELECTRODE |
| | CAPACITY | HEAT-FLOW | ACTIVE | ACTIVE |
| | RATIO | VALUE RATIO | MATERIAL | MATERIAL |
| EXAMPLE 5 | 1.09 | 0.31 | 1-1 | 2-6 |
| EXAMPLE 6 | 1.02 | 0.29 | 1-1 | 2-7 |
| COMPARATIVE | 0.93 | 0.27 | 1-1 | 2-8 |
| EXAMPLE 5 | | | | |

TABLE 6

| | | | FIRST | SECOND |
|---|---|---|---|---|
| | | | POSITIVE- | POSITIVE- |
| | | MAXIMUM | ELECTRODE | ELECTRODE |
| | CAPACITY | HEAT-FLOW | ACTIVE | ACTIVE |
| | RATIO | VALUE RATIO | MATERIAL | MATERIAL |
| EXAMPLE 7 | 1.16 | 0.42 | 1-6 | 2-2 |
| EXAMPLE 8 | 1.04 | 0.30 | 1-7 | 2-2 |
| EXAMPLE 9 | 1.12 | 0.41 | 1-1 | 2-9 |
| COMPARATIVE | 1.18 | 0.58 | 1-5 | 2-2 |
| EXAMPLE 6 | | | | |
| COMPARATIVE | 0.94 | 0.34 | 1-8 | 2-2 |
| EXAMPLE 7 | | | | |
| COMPARATIVE | 0.94 | 0.32 | 1-1 | 2-10 |
| EXAMPLE 8 | | | | |

TABLE 7

| | | | FIRST | SECOND |
|---|---|---|---|---|
| | | | POSITIVE- | POSITIVE- |
| | | MAXIMUM | ELECTRODE | ELECTRODE |
| | CAPACITY | HEAT-FLOW | ACTIVE | ACTIVE |
| | RATIO | VALUE RATIO | MATERIAL | MATERIAL |
| EXAMPLE 10 | 1.12 | 0.29 | 1-10 | 2-2 |
| EXAMPLE 11 | 1.04 | 0.35 | 1-11 | 2-2 |
| EXAMPLE 12 | 1.13 | 0.29 | 1-1 | 2-12 |
| EXAMPLE 13 | 1.05 | 0.31 | 1-1 | 2-13 |
| COMPARATIVE | 0.98 | 0.30 | 1-9 | 2-2 |
| EXAMPLE 9 | | | | |
| COMPARATIVE | 0.97 | 0.41 | 1-12 | 2-2 |
| EXAMPLE 10 | | | | |
| COMPARATIVE | 0.98 | 0.34 | 1-1 | 2-11 |
| EXAMPLE 11 | | | | |
| COMPARATIVE | 0.96 | 0.32 | 1-1 | 2-14 |
| EXAMPLE 12 | | | | |

TABLE 8

| | | | FIRST | SECOND |
|---|---|---|---|---|
| | | | POSITIVE- | POSITIVE- |
| | | MAXIMUM | ELECTRODE | ELECTRODE |
| | CAPACITY | HEAT-FLOW | ACTIVE | ACTIVE |
| | RATIO | VALUE RATIO | MATERIAL | MATERIAL |
| EXAMPLE 14 | 1.10 | 0.28 | 1-13 | 2-2 |
| COMPARATIVE | 0.96 | 0.30 | 1-14 | 2-2 |
| EXAMPLE 13 | | | | |
| COMPARATIVE | 1.06 | 0.54 | 1-1 | 2-15 |
| EXAMPLE 14 | | | | |
| COMPARATIVE | 0.97 | 0.29 | 1-1 | 2-16 |
| EXAMPLE 15 | | | | |

TABLE 9

| | | | FIRST | SECOND |
|---|---|---|---|---|
| | | | POSITIVE- | POSITIVE- |
| | | MAXIMUM | ELECTRODE | ELECTRODE |
| | CAPACITY | HEAT-FLOW | ACTIVE | ACTIVE |
| | RATIO | VALUE RATIO | MATERIAL | MATERIAL |
| EXAMPLE 15 | 1.18 | 0.31 | 1-1(70) | 2-2(30) |
| EXAMPLE 16 | 1.07 | 0.34 | 1-1(30) | 2-2(70) |
| COMPARATIVE | 0.99 | 0.38 | 1-1(20) | 2-2(80) |
| EXAMPLE 16 | | | | |

Next, explanation will be given below regarding Table 4. Table 4 is a table comparing Examples 1 to 4 and Comparative Examples 1 to 4. In Examples 1 to 4 and Comparative Examples 1 to 4, the mixture ratio of the first positive-electrode active material and the second positive-electrode active material is equal to 50:50 in mass ratio.

In Example 1, a positive-electrode material was prepared using the first positive-electrode active material 1-1 and the second positive-electrode active material 2-2. In the first positive-electrode active material 1-1, Mo is used as M1 of the composition formula and Co as M2, and the Li content is equal to 110%. The Ni content among the transition metals is 80%, the Co content is 16%, and the Mo content is 4%. In the second positive-electrode active material 2-2, Co is used as M3 of the composition formula, and the Li content is equal to 103%. The Ni content among the transition metals is 80%, the Co content is 10%, and the Ti content is 10%.

In Example 2, the positive-electrode material was prepared using the first positive-electrode active material 1-2 and the second positive-electrode active material 2-2. In the first positive-electrode active material 1-2, W is used as M1 of the composition formula and Co is used as M2. The Ni content among the transition metals is 80%, the Co content is 16%, and the W content is 4%.

In Example 3, the positive-electrode material was prepared using the first positive-electrode active material 1-3 and the second positive-electrode active material 2-2. In the first positive-electrode active material 1-3, Mo is used as M1 of the composition formula, and Co and Mn are used as M2. The Ni content among the transition metals is 80%, the Co content is 12%, the Mn content is 4%, and the Mo content is 4%.

In Example 4, the positive-electrode material was prepared using the first positive-electrode active material 1-4 and the second positive-electrode active material 2-2. In the first positive-electrode active material 1-4, Mo is used as M1 of the composition formula, and Co and Mn are used as M2. The Ni content among the transition metals is 80%, the Co content is 8%, the Mn content is 8%, and Mo content is 4%.

In Comparative Example 1, the positive-electrode material was prepared using only the second positive-electrode active material 2-1, and without using the first positive-electrode active material. In the second positive-electrode active material 2-1, Ti is not contained, while Co and Mn are used as M3 of the composition formula. The Ni content among the transition metals is 60%, the Co content is 20%, and the Mn content is 20%.

In Comparative Example 2, the positive-electrode material was prepared using the first positive-electrode active material 1-1 and the second positive-electrode active material 2-3. In the second positive-electrode active material 2-3, Ti is not contained while Zr is contained. Co is used as M3 of the composition formula. The Ni content among the transition metals is 80%, the Co content is 10%, and the Zr content is 10%.

In Comparative Example 3, the positive-electrode material was prepared using the first positive-electrode active material 1-1 and the second positive-electrode active material 2-4. In the second positive-electrode active material 2-4, Ti is not contained while Al is contained. Co is used as M3 of the composition formula. The Ni content among the transition metals is 80%, the Co content is 10%, and the Al content is 10%. In Comparative Example 4, the positive-electrode material was prepared using the first positive-electrode active material 1-1 and the second positive-electrode active material 2-5. In the second positive-electrode active material 2-5, Ti is not contained while Mg is contained. Co is used as M3 of the composition formula. The Ni content among the transition metals is 80%, the Co content is 10%, and the Mg content is 10%.

In Table 4, a result was obtained that the discharge capacities of Examples 1 to 4 are greater than the discharge capacity of Comparative Example 1, and the maximum heat-flow values of Examples 1 to 4 are smaller than or equal to the one-half of the maximum heat-flow value of Comparative Example 1. It is conceivable that the greater values of the discharge capacities are attributed to the fact that the content of Ni existing in the transition-metal layer is large in amount, i.e., 80%. Further, it is conceivable that the significant reduction in the maximum heat-flow value, i.e., the maximum heat-flow value smaller than or equal to the one-half in Comparative Example, can be attributed to the facts that, in the first positive-electrode active material, the element (i.e., Mo or W) capable of enhancing the thermal stability in the charged state exists in the transition-metal layer by an amount of 4%, and further, in the second positive-electrode active material, the element (i.e., Ti), having a heat-flow temperature range different from the one in the first positive-electrode active material and capable of reducing the maximum heat-flow value, exists by an amount of 10%.

Further, from Examples 3 and 4, it was found that, similarly to the case where Co is used, the use of Co and Mn as M2 of the composition formula of the first positive-electrode active material also attain simultaneous compatibility between the enhancement in the discharge capacity and the significant reduction in the maximum heat-flow value.

On the other hand, in Comparative Example 1, the first positive-electrode active material containing Mo or W is not used so that the reduction of the maximum heat-flow value could not be attained. Also, the content of Ni in the second positive-electrode active material 2-1 is small in amount, i.e., 60%, so that the enhancement of the discharge capacity could not be attained. Further, in Comparative Examples 2 to 4, the simultaneous compatibility between the enhancement in the discharge capacity and the reduction in the maximum heat-flow value down to the value smaller than or equal to the one-half of Comparative Example 1 could not be attained. In Comparative Examples 2 to 4, Ti is not contained in the second positive-electrode active material so that the heat-flow-amount reducing effect was small.

From the above-described findings, it was found that, when the first positive-electrode active material and the second positive-electrode active material are used; Ni is caused to be contained into the first positive-electrode active material and the second positive-electrode active material by the amount of 80% of the transition metals; Mo or W is caused to be contained into the first positive-electrode active material by the amount of 4% of the transition metals; and Ti is caused to be contained into the second positive-electrode active material by the amount of 10% of the transition metals, the simultaneous compatibility between the enhancement in the discharge capacity and the significant reduction in the maximum heat-flow value can be attained.

Next, explanation will be given below concerning Table 5. Table 5 is a table comparing Examples 5 and 6 and Comparative Example 5. In Examples 5 and 6 and Comparative Example 5, the mixture ratio of the first positive-electrode active material and the second positive-electrode active material is equal to 50:50 in mass ratio.

In Example 5, the positive-electrode material was prepared using the first positive-electrode active material 1-1 and the second positive-electrode active material 2-6. In the second positive-electrode active material 2-6, Co and Mn are used as M3 of the composition formula. The Ni content among the transition metals is 70%, the Co content is 15%, the Mn content is 5%, and the Ti content is 10%.

In Example 6, the positive-electrode material was prepared using the first positive-electrode active material 1-1 and the second positive-electrode active material 2-7. In the second positive-electrode active material 2-7, Co and Mn are used as M3 of the composition formula. The Ni content among the transition metals is 70%, the Co content is 10%, the Mn content is 10%, and the Ti content is 10%.

In Comparative Example 5, the positive-electrode material was prepared using the first positive-electrode active material 1-1 and the second positive-electrode active material 2-8. In the second positive-electrode active material 2-8, Co and Mn are used as M3 of the composition formula. The Ni content among the transition metals is 70%, the Co content is 5%, the Mn content is 15%, and the Ti content is 10%.

In Table 5, a result was obtained that the discharge capacities of Examples 5 and 6 are greater than the discharge capacity of Comparative Example 5, and the maximum heat-flow values of Examples 5 and 6 are smaller than or equal to the one-half of the maximum heat-flow value of Comparative Example 5. It is conceivable that, in Examples 5 and 6, this result is due to the fact that the content of Ni in the second positive-electrode active material is large in amount, i.e., greater than or equal to 70%, and that the content of Co is greater than or equal to the content of Mn.

On the other hand, in Comparative Example 5, simultaneous compatibility between the enhancement in the discharge capacity and the significant reduction in the maximum heat-flow value could not be attained. In Comparative Example 5, Mn exists in greater amount than Co in the second positive-electrode active material so that the discharge capacity was significantly reduced.

From the above-described findings, it was found that, when Ni is caused to be contained to the second positive-electrode active material by the amount of 70% of the transition metals and the content of Co is made greater than or equal to the content of Mn in this second material, the simultaneous compatibility between the enhancement in the discharge capacity and the significant reduction in the maximum heat-flow value can be attained.

Next, explanation will be given below regarding Table 6. Table 6 is a table comparing Examples 7 to 9 with Comparative Examples 6 to 8. In Examples 7 to 9 and Comparative Examples 6 to 8, the mixture ratio of the first positive-electrode active materials and the second positive-electrode active materials is equal to 50:50 in mass ratio.

In Example 7, the positive-electrode material was prepared using the first positive-electrode active material 1-6 and the second positive-electrode active material 2-2. In the first positive-electrode active material 1-6, Mo is used as Ml of the composition formula and Co is used as M2. The Ni content among the transition metals is 80%, the Co content is 18%, and the Mo content is 2%.

In Example 8, the positive-electrode material was prepared using the first positive-electrode active material 1-7 and the second positive-electrode active material 2-2. In the first positive-electrode active material 1-7, Mo is used as M1 of the composition formula and Co is used as M2. The Ni content among the transition metals is 80%, the Co content is 14%, and the Mo content is 6%.

In Example 9, the positive-electrode material was prepared using the first positive-electrode active material 1-1 and the second positive-electrode active material 2-9. In the second positive-electrode active material 2-9, Co and Mn are used as M3 of the composition formula. The Ni content among the transition metals is 70%, the Co content is 15%, the Mn content is 10%, and the Ti content is 5%.

In Comparative Example 6, the positive-electrode material was prepared using the first positive-electrode active material 1-5 and the second positive-electrode active material 2-2. In the first positive-electrode active material 1-5, M1 of the composition formula is not contained, and Co is used as M2. The Ni content among the transition metals is 80% and the Co content is 20%.

In Comparative Example 7, the positive-electrode material was prepared using the first positive-electrode active material 1-8 and the second positive-electrode active material 2-2. In the first positive-electrode active material 1-8, Mo is used as MI of the composition formula and Co is used as M2. The Ni content among the transition metals is 80%, the Co content is 12%, and the Mo content is 8%.

In Comparative Example 8, the positive-electrode material was prepared using the first positive-electrode active material 1-1 and the second positive-electrode active material 2-10. In the second positive-electrode active material 2-10, Co and Mn are used as M3 of the composition formula. The Ni content among the transition metals is 70%, the Co content is 5%, the Mn content is 10%, and the Ti content is 15%.

In Table 6, a result was obtained that the discharge capacities of Examples 7 to 9 are greater than the discharge capacity of Comparative Example 1, and the maximum heat-flow values of Examples 7 to 9 are smaller than or equal to the one-half of the maximum heat-flow value of Comparative Example 1. It is conceivable that the greater value of the discharge capacity can be attributed to the fact that, in the positive-electrode material formed in Examples 7 to 9, the content of Ni existing in the transition-metal layer is large in amount, i.e., greater than or equal to 80%, the content of Mo is smaller than or equal to 6% in the first positive-electrode active material, and the content of Ti is smaller than or equal to 10% in the second positive-electrode active material. Further, it is conceivable that the significant reduction in the maximum heat-flow value can be attributed to the fact that, in the first positive-electrode active material, the element (i.e., Mo) capable of enhancing the thermal stability in the charged state exists in the transition-metal layer by an amount greater than or equal to 2%, and further, in the second positive-electrode active material, the element (i.e., Ti), having a heat-flow temperature range different from the one in the first positive-electrode active material and capable of reducing the maximum heat-flow value, exists by an amount greater than or equal to 5%.

On the other hand, in Comparative Examples 6 to 8, simultaneous compatibility between the enhancement in the discharge capacity and the reduction in the maximum heat-flow value down to the value smaller than or equal to the one-half in Comparative Example could not be attained. In Comparative Example 6, since Mo is not contained in the first positive-electrode active material, the thermal stability could not be enhanced so that the maximum heat-flow value could not be reduced down to the one-half. In Comparative Example 7, in the first positive-electrode active material, the content of Mo is large in amount, i.e., 8% so that the discharge capacity was significantly reduced. Further, in Comparative Example 8, the content of Ti is large in amount, i.e., 15% in the second positive-electrode active material, and Mn exists in great amount than Co, so that the discharge capacity was significantly reduced.

From the above-described findings, it was found that, when Mo is caused to be contained into the first positive-electrode active material by an amount greater than or equal to 2% and smaller than or equal to 6%, and Ti is caused to be contained in the second positive-electrode active material by an amount of greater than or equal to 5% and smaller than or equal to 10%, the simultaneous compatibility between the enhancement in the discharge capacity and the significant reduction in the maximum heat-flow value could be attained. In addition, as indicated from the result (i.e., Table 4) obtained in Examples 1 and 2, W may also be used instead of Mo. This is because W is also the element capable of enhancing the thermal stability in the charged state.

Next, the explanation will be given below concerning Table 7. Table 7 is a table on which the comparison is made between Examples 10 to 13 and Comparative Examples 9 to 12. The mixture ratio (i.e., mass ratio) of the first positive-electrode active material and the second positive-electrode active material is equal to 50:50.

In Example 10, the positive-electrode material was prepared using the first positive-electrode active material 1-10 and the second positive-electrode active material 2-2. In the first positive-electrode active material 1-10, Mo is used as M1 of the composition formula and Co is used as M2. The Li content is equal to 103%. The Ni content among the transition metals is 80%, the Co content is 16%, and the Mo content is 4%.

In Example 11, the positive-electrode material was prepared using the first positive-electrode active material 1-11 and the second positive-electrode active material 2-2. In the first positive-electrode active material 1-11, Mo is used as M1 of the composition formula and Co is used as M2. The Li content is equal to 120%. The Ni content among the transition metals is 80%, the Co content is 16%, and the Mo content is 4%.

In Example 12, the positive-electrode material was prepared using the first positive-electrode active material 1-1 and the second positive-electrode active material 2-12. In the second positive-electrode active material 2-12, Co is used as M3 of the composition formula. The Li content is equal to 100%. The Ni content among the transition metals is 80%, the Co content is 10%, and the Ti content is 10%.

In Example 13, the positive-electrode material was prepared using the first positive-electrode active material 1-1 and the second positive-electrode active material 2-13. In the second positive-electrode active material 2-13, Co is used as M3 of the composition formula. The Li content is equal to 110%. The Ni content among the transition metals is 80%, the Co content is 10%, and the Ti content is 10%.

In Comparative Example 9, the positive-electrode material was prepared using the first positive-electrode active material 1-9 and the second positive-electrode active material 2-2. In the first positive-electrode active material 1-9, Mo is used as M1 of the composition formula and Co is used as M2, respectively. The Li content is equal to 100%. The Ni content among the transition metals is 80%, the Co content is 16%, and the Mo content is 4%.

In Comparative Example 10, the positive-electrode material was prepared using the first positive-electrode active material 1-12 and the second positive-electrode active material 2-2. In the first positive-electrode active material 1-12, Mo is used as M1 of the composition formula and Co is used as M2. The Li content is equal to 125%. The Ni content among the transition metals is 80%, the Co content is 16%, and the Mo content is 4%.

In Comparative Example 11, the positive-electrode material was prepared using the first positive-electrode active material 1-1 and the second positive-electrode active material 2-11. In the second positive-electrode active material 2-11, Co is used as M3 of the composition formula. The Li content is equal to 97%. The Ni content among the transition metals is 80%, the Co content is 10%, and the Ti content is 10%.

In Comparative Example 12, the positive-electrode material was prepared using the first positive-electrode active material 1-1 and the second positive-electrode active material 2-14. The mixture ratio of the first positive-electrode active material and the second positive-electrode active material is equal to 20 : 80 in mass ratio. In the second positive-electrode active material 2-14, Co is used as M3 of the composition formula. The Li content is equal to 115%. The Ni content among the transition metals is 80%, the Co content is 10%, and the Ti content is 10%.

In Table 7, a result was obtained that the discharge capacities of Examples 10 to 13 are greater than the discharge capacity of Comparative Example 1 and the maximum heat-flow values of Examples 10 to 13 are smaller than or equal to the one-half of the maximum heat-flow value of Comparative Example 1. It is conceivable that the greater value of the discharge capacity can be attributed to the facts that, in the positive-electrode material formed in Examples 10 to 13, the content of Ni existing in the transition-metal layer is large in amount, i.e., 80%, and further, in the first positive-electrode active material, the Li content is greater than or equal to 103% and is smaller than or equal to 120%, and in the second positive-electrode active material, the Li content is greater than or equal to 100% and is smaller than or equal to 110%. Further, it is conceivable that the significant reduction in the maximum heat-flow value can be attributed to the facts that, in the first positive-electrode active material, the element (i.e., Mo) capable of enhancing the thermal stability in the charged state exists in the transition-metal layer by an amount of 4%, and further, in the second positive-electrode active material, the element (i.e., Ti), having a heat-flow temperature range different from the one in the first positive-electrode active material and capable of reducing the maximum heat-flow value, exists by an amount of 10%.

On the other hand, in Comparative Examples 9 to 12, enhancement in the discharge capacity and the reduction in the maximum heat-flow value down to the value smaller than or equal to the one-half in Comparative Example could not be attained. In Comparative Example 9, the Li content is small in amount, i.e., 100% in the first positive-electrode active material, so that the discharge capacity was small. In Comparative Example 10, the Li content is large in amount, i.e., 125% in the first positive-electrode active material, so that the discharge capacity was small. In Comparative Example 11, the Li content is small in amount, i.e., 97% in the second positive-electrode active material, so that the discharge capacity was small. In Comparative Example 12, the Li content is large in amount, i.e., 115% in the second positive-electrode active material, so that the discharge capacity was small.

From the above-described findings, it was found that, when Li is caused to be contained into the first positive-electrode active material by the amount of being greater than or equal to 103% and smaller than or equal to 120%, and Li is caused to be contained in the second positive-electrode active material by the amount greater than or equal to 100% and smaller than or equal to 110%, the simultaneous compatibility between the enhancement in the discharge capacity and the significant reduction in the maximum heat-flow value can be attained.

Next, explanation will be given below regarding Table 8. Table 8 is a table comparing Example 14 and Comparative Examples 13 to 15. The mixture ratio (i.e., mass ratio) of the first positive-electrode active material and the second positive-electrode active material is equal to 50:50.

In Example 14, the positive-electrode material was prepared using the first positive-electrode active material 1-13 and the second positive-electrode active material 2-2. In the first positive-electrode active material 1-13, Mo is used as Ml of the composition formula and Co is used as M2. The Li content is equal to 110%. The Ni content among the transition metals is 70%, the Co content is 26%, and the Mo content is 4%.

In Comparative Example 13, the positive-electrode material was prepared using the first positive-electrode active material 1-14 and the second positive-electrode active material 2-2. In the first positive-electrode active material 1-14, Mo is used as M1 of the composition formula and Co is used as M2. The Li content is equal to 110%. The Ni content among the transition metals is 60%, the Co content is 36%, and the Mo content is 4%.

In Comparative Example 14, the positive-electrode material was prepared using the first positive-electrode active material 1-1 and the second positive-electrode active material 2-15. In the second positive-electrode active material 2-15, M3 of the composition formula is not used. The Ni content among the transition metals is 90% and the Ti content is 10%.

In Comparative Example 15, the positive-electrode material was prepared using the first positive-electrode active material 1-1 and the second positive-electrode active material 2-16. In the second positive-electrode active material 2-16, Co is used as M3 of the composition formula. The Ni content among the transition metals is 60%, the Co content is 30%, and the Ti content is 10%.

In Table 8, a result was obtained that the discharge capacity of Example 14 is greater than the discharge capacity of Comparative Example 1, and the maximum heat-flow value of Example 14 is smaller than or equal to the one-half of the maximum heat-flow value of Comparative Example 1. It is conceivable that the greater value of the discharge capacity can be attributed to the fact that, in the positive-electrode material formed in Example 14, the content of Ni existing in the transition-metal layer is large in amount, i.e., greater than or equal to 70%. Further, it is conceivable that the significant reduction in the maximum heat-flow value can be attributed to the facts that, in the first positive-electrode active material, the element (i.e., Mo) capable of enhancing the thermal stability in the charged state exists in the transition-metal layer by an amount of 4%, and further, in the second positive-electrode active material, the element (i.e., Ti), having a heat-flow temperature range different from the one in the first positive-electrode active material and capable of reducing the maximum heat-flow value, exists by an amount of 10%.

On the other hand, in Comparative Examples 13 to 15, simultaneous compatibility between the enhancement in the discharge capacity and the reduction in the maximum heat-flow value down to the value smaller than or equal to the one-half in Comparative Example could not be attained.

In Comparative Example 13, the content of Ni is too small in amount, i.e., 60% in the first positive-electrode active material, so that the discharge capacity was small. In Comparative Example 14, the content of Ni is too large in amount, i.e., 90% in the second positive-electrode active material, so that the thermal stability could not be enhanced. In Comparative Example 15, the content of Ni is too small in amount, i.e., 60% in the second positive-electrode active material, so that the discharge capacity was small.

From the above-described findings, it was found that, when in the first positive-electrode active material and the second positive-electrode active material, the content of Ni is made smaller than or equal to 60%, the discharge capacity is lowered. Further, it was found that, when the content of Ni is made greater than or equal to 90% in the second positive-electrode active material, the maximum heat-flow value is reduced down to the value smaller than or equal to the one-half in Comparative Example.

Next, explanation will be given below concerning Table 9. Table 9 is a table comparing Examples 15 and 16 and Comparative Example 16.

In Example 15, the positive-electrode material was prepared using the first positive-electrode active material 1-1 and the second positive-electrode active material 2-2. The mixture ratio (i.e., mass ratio) of the first positive-electrode active material and the second positive-electrode active material is equal to 70:30.

In Example 16, the positive-electrode material was prepared using the first positive-electrode active material 1-1 and the second positive-electrode active material 2-2. The mixture ratio (i.e., mass ratio) of the first positive-electrode active material and the second positive-electrode active material is equal to 30:70.

In Comparative Example 16, the positive-electrode material was prepared using the first positive-electrode active material 1-1 and the second positive-electrode active material 2-2. The mixture ratio (i.e., mass ratio) of the first positive-electrode active material and the second positive-electrode active material is equal to 20:80.

In Table 9, a result was obtained that the discharge capacities of Examples 15 and 16 are greater than the discharge capacity of Comparative Example 1, and the maximum heat-flow values of Examples 15 and 16 are smaller than or equal to the one-half of the maximum heat-flow value of Comparative Example 1. It is conceivable that the greater value of the discharge capacity can be attributed to the facts that, in the positive-electrode material formed in Examples 15 and 16, the content of Ni existing in the transition-metal layer is large in amount, i.e., 80%, and the percentage of the first positive-electrode active material (whose discharge capacity is large) relative to the sum of the first positive-electrode active material and the second positive-electrode active material is greater than or equal to 30% in mass ratio. Further, it is conceivable that the significant reduction in the maximum heat-flow value, i.e., the maximum heat-flow value smaller than or equal to the one-half in Comparative Example, can be attributed to the facts that, in the first positive-electrode active material, the element (i.e., Mo) capable of enhancing the thermal stability in the charged state exists in the transition-metal layer by an amount of 4%, and further, in the second positive-electrode active material, the element (i.e., Ti), having a heat-flow temperature range different from the one in the first positive-electrode active material and capable of reducing the maximum heat-flow value, exists by an amount of 10%.

On the other hand, in Comparative Example 16, simultaneous compatibility between the enhancement in the discharge capacity and the reduction in the maximum heat-flow value down to the value smaller than or equal to the one-half in Comparative Example could not be attained. In Comparative Example 16, the percentage of the first positive-electrode active material (whose discharge capacity is large) relative to the sum of the first positive-electrode active material and the second positive-electrode active material is small, i.e., 20% in mass ratio, so that the discharge capacity was small as a whole.

From the above-described findings, it was found that, when the percentage of the first positive-electrode active material relative to the sum of the first positive-electrode active material and the second positive-electrode active material is made greater than or equal to 30% in mass ratio, the simultaneous compatibility between the enhancement in the discharge capacity and the significant reduction in the maximum heat-flow value can be attained.

From the results represented in Tables 4 to 9, it was found that, it is preferable to use the following positive-electrode material in order to implement the simultaneous compatibility between the enhancement in the discharge capacity and the significant reduction in the maximum heat-flow value: the positive-electrode material including the first positive-electrode active material and the second positive-electrode active material which will be specified next, and further, the percentage of the first positive-electrode active material relative to the sum of the first positive-electrode active material and the second positive-electrode active material being greater than or equal to 30% in mass ratio.

The first positive-electrode active material is specified such that the Li content is made greater than or equal to 103%, and smaller than or equal to 120%; the content of Ni existing in the transition-metal layer is made greater than 60%, and smaller than 98%; Mo or W is used as M1 of the composition formula which denotes the first positive-electrode active material; the content of M1 existing in the transition-metal layer is made greater than or equal to 2%, and smaller than or equal to 6%; and Co is used as M2 of the composition formula, or Mn and Co are used as M2.

The second positive-electrode active material is specified such that the Li content is made greater than or equal to 100%, and smaller than or equal to 110%; the content of Ni existing in the transition-metal layer is made greater than or equal to 70%, and smaller than or equal to 80%; the content of Ti existing in the transition-metal layer is made greater than or equal to 5%, and smaller than or equal to 10%; and Co is used as M3 of the composition formula which denoted the second positive-electrode active material, or Mn and Co are used as M3.

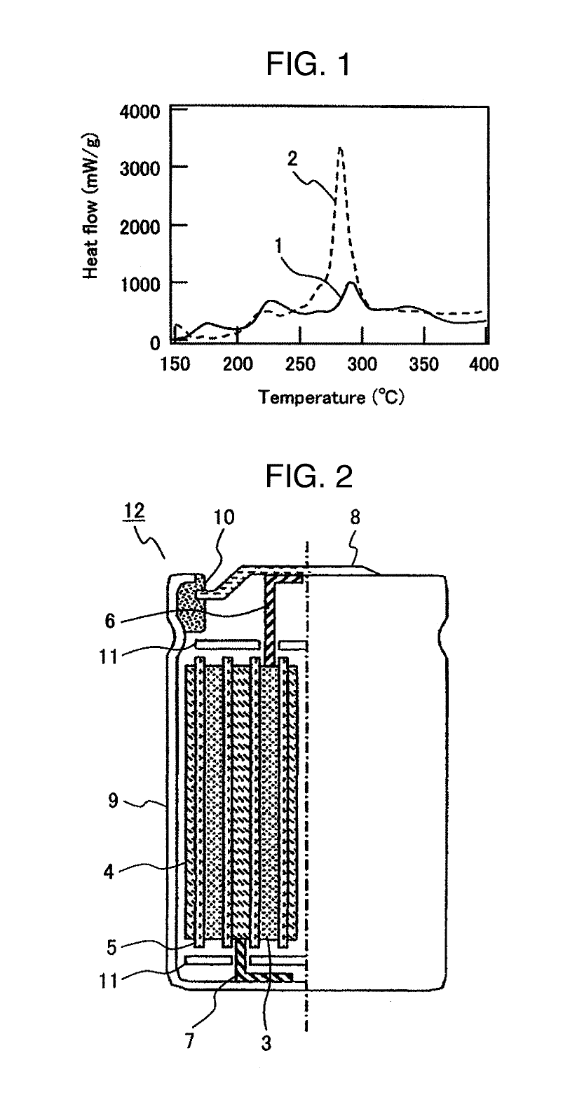

FIG. 1 is a graph for illustrating the results of differential-scanning heat amount measurements on prototype batteries according to Example 1 and Comparative Example 1. The horizontal axis denoted the temperature, and the longitudinal axis denoted the heat flow. A reference numeral 1 denotes the result obtained for Example 1, and a reference numeral 2 denotes the result obtained for Comparative Example 1. As is shown in FIG. 1, the prototype battery according to Example 1 is, as a whole, smaller in its heat-flow amount as compared with the prototype battery according to Comparative Example 1. From this fact, it can be understood that the positive-electrode material used in Example 1 is smaller in its maximum heat-flow value due to the heat-flow reaction as compared with the positive-electrode material used in Comparative Example 1, and that the positive-electrode material used in Example 1 exhibits high-safety characteristics.

FIG. 2 is a cross-sectional view of the lithium secondary battery according to Examples of the present invention. The lithium secondary battery 12 illustrated in FIG. 2 includes an electrode group provided with a positive-electrode plate 3 formed by coating a positive-electrode material on both surfaces of an electricity collector, a negative-electrode plate 4 formed by coating a negative-electrode material on both surfaces of the electricity collector, and separators 5. In the present Examples, the positive-electrode plate 3 and the negative-electrode plate 4 are wound around with the separators 5 placed therebetween, thereby forming the electrode group of the wound-around body. This wound-around body is inserted into a battery can 9.

The negative-electrode plate 4 is electrically connected to the battery can 9 via a negative-electrode lead fragment 7. A hermetically-sealed lid unit 8 is fixed onto the battery can 9 with a packing 10 placed therebetween. The positive-electrode plate 3 is electrically connected to the hermetically-sealed lid unit 8 via a positive-electrode lead fragment 6. The wound-around body is insulated by an insulating plate 11.

In addition, the electrode group is not necessarily required to be the wound-around body as is illustrated in FIG. 2, and it may also be a multi-layered body which is formed by multi-layering the positive-electrode plate 3 and the negative-electrode plate 4 with the separators 5 placed therebetween.

By using the positive electrode formed by coating the positive-electrode material specified in the present Examples as the positive-electrode plate 3 of the lithium secondary battery 12, the high-capacity and high-safety lithium secondary battery can be obtained. Consequently, according to the present invention, it becomes possible to provide the positive-electrode material and the lithium secondary battery which can attain the high-capacity, high-output, and high-safety characteristics demanded for the battery for plug-in hybrid car use.

The present invention is applicable to the positive-electrode material for the lithium secondary battery, and this lithium secondary battery. In particular, the present invention is applicable to the lithium secondary battery for plug-in hybrid car use.

1. A positive-electrode material, comprising:
a first positive-electrode active material being denoted by a composition formula Li_{1.1+x}NiₐM1_{b}M2_{c}O₂ (M1 denoting Mo or W, M2 denoting Co, or Co and Mn, −0.07≦x≦0.1, 0.7≦a≦0.98, 0.02≦b≦0.06, 0≦c≦0.28),
a second positive-electrode active material being denoted by a composition formula Li_{1.03+x} NiₐTi_{b}M3_{c}O₂ (M3 denoting Co, or Co and Mn, −0.03≦x≦0.07, 0.7≦a≦0.8, 0.05≦b≦0.1, 0.1≦c≦0.25),
wherein percentage of said first positive-electrode active material relative to sum of said first positive-electrode active material and said second positive-electrode active material is greater than or equal to 30% in mass ratio.

2. The positive-electrode material according to claim 1, wherein a content of Co is greater than or equal to a content of Mn when said second positive-electrode active material contains Co and Mn as M3.

3. A lithium secondary battery, comprising:
a positive electrode capable of storing and releasing lithium;
a negative electrode capable of storing and releasing lithium; and
separators,
wherein said positive-electrode material according to claim 1 is used for said positive electrode.
